(19) United States
(12) Patent Application Publication
(10) Pub. No.: US 2018/0184436 A1
(43) Pub. Date: Jun. 28, 2018

(54) APPARATUS AND METHOD FOR SELECTING RELAY

(71) Applicant: NEC CORPORATION, Tokyo (JP)

(72) Inventors: Taichi OHTSUJI, Tokyo (JP); Kazushi MURAOKA, Tokyo (JP); Hiroaki AMINAKA, Tokyo (JP)

(73) Assignee: NEC CORPORATION, Tokyo (JP)

(21) Appl. No.: 15/579,735

(22) PCT Filed: Jan. 28, 2016
(86) PCT No.: PCT/JP2016/000432

§ 371 Date: Dec. 5, 2017

(30) Foreign Application Priority Data
Jun. 24, 2015 (JP) 2015-126676

(51) Int. Cl. H04W 72/08; H04B 7/14; H04W 8/00

(52) U.S. Cl. CPC H04W 72/085; H04W 76/10; H04W 8/005; H04B 7/14

(57) ABSTRACT

A relay selecting apparatus (1, 3 or 5) is configured to select at least one specific relay terminal (2) suitable for a remote terminal (1) from among one or more relay terminals (2) based on a selection criterion that considers a time variation of a device-to-device (D2D) link quality between the remote terminal (1) and each of the one or more relay terminals (2). In this way, it is possible to contribute to improving a relay selection so as to provide a stable relay quality.

### TECHNICAL FIELD

The present disclosure relates to inter-terminal direct communication (i.e., device-to-device (D2D) communication) and, in particular, to a selection of a relay terminal.

### BACKGROUND ART

In some implementations, a radio terminal is configured to directly communicate with other radio terminals. Such communication is referred to as device-to-device (D2D) communication. The D2D communication includes at least one of direct communication and direct discovery. In some implementations, a plurality of radio terminals supporting D2D communication form a D2D communication group autonomously or under the control of a network, and perform communication with other radio terminals in the formed D2D communication group.

3GPP Release 12 specifies Proximity-based services (ProSe) (see, for example, Non-patent Literature 1). ProSe includes ProSe discovery and ProSe direct communication. ProSe discovery makes it possible to detect proximity (in proximity) of radio terminals. ProSe discovery includes direct discovery (ProSe Direct Discovery) and network-level discovery (EPC-level ProSe Discovery).

ProSe Direct Discovery is performed through a procedure in which a radio terminal capable of performing ProSe (i.e., ProSe-enabled User Equipment (UE)) detects another ProSe-enabled UE by using only the capability of a radio communication technology (e.g., Evolved Universal Terrestrial Radio Access (E-UTRA) technology) possessed by these two UEs. On the other hand, in EPC-level ProSe Discovery, a core network (i.e., Evolved Packet Core (EPC)) determines proximity of two ProSe-enabled UEs and notifies these UEs of the detection of proximity. ProSe Direct Discovery may be performed by three or more ProSe-enabled UEs.

ProSe direct communication enables establishment of a communication path(s) between two or more ProSe-enabled UEs existing in a direct communication range after the ProSe discovery procedure is performed. In other words, ProSe direct communication enables a ProSe-enabled UE to directly communicate with another ProSe-enabled UE, without traversing a Public Land Mobile Network (PLMN) including a base station (eNodeB). ProSe direct communication may be performed by using a radio communication technology that is also used to access a base station (eNodeB) (i.e., E-UTRA technology) or by using a wireless radio access network (WLAN) radio technology (i.e., IEEE 802.11 radio technology).

ProSe direct discovery and ProSe direct communication are performed on an inter-UE direct interface. This direct interface is referred to as a PC5 interface or a sidelink. That is, ProSe direct discovery and ProSe direct communication are examples of the D2D communication. The D2D communication can be referred to as sidelink communication or peer-to-peer communication.

In 3GPP Release 12, a ProSe function communicates with a ProSe-enabled UE through a Public Land Mobile Network (PLMN) and assists ProSe discovery and ProSe direct communication. The ProSe function is a logical function that is used for PLMN-related operations required for ProSe. The functionality provided by the ProSe function includes, for example: (a) communication with third-party applications (a ProSe Application Server), (b) authentication of a UE for ProSe discovery and ProSe direct communication, (c) transmission of configuration information for ProSe discovery and ProSe direct communication (e.g., EPC-ProSe-User ID) to a UE, and (d) providing of network-level discovery (i.e., EPC-level ProSe discovery). The ProSe function may be implemented in one or more network nodes or entities. In this specification, one or more network nodes or entities that implement the ProSe function are referred to as “ProSe function entities” or “ProSe function servers”.

3GPP Release 12 further defines a partial coverage scenario where one UE is located outside the network coverage and another UE is located within the network coverage (see, for example, Sections 4.4.3, 4.5.4 and 5.4.4 of Non-Patent Literature 1). In the partial coverage scenario, the UE outside the coverage is referred to as a “remote UE”, and the UE that is in coverage and performs relaying between the remote UE and the network is referred to as a “ProSe UE-to-Network Relay”. The ProSe UE-to-Network Relay relays traffic (downlink and uplink) between the remote UE and the network (E-UTRA network (E-UTRAN) and EPC)

More specifically, the ProSe UE-to-Network Relay attaches to the network as a UE, establishes a PDN connection to communicate with a ProSe function entity or another Packet Data Network (PDN), and communicates with the ProSe function entity to start ProSe direct communication. The ProSe UE-to-Network Relay further performs the discovery procedure with the remote UE, communicates with the remote UE on the inter-UE direct interface (e.g., sidelink or PC5 interface), and relays traffic (downlink and uplink) between the remote UE and the network. When the Internet Protocol version 4 (IPv4) is used, the ProSe UE-to-Network Relay operates as a Dynamic Host Configuration Protocol Version 4 (DHCPv4) Server and Network Address Translation (NAT). When the IPv6 is used, the ProSe UE-to-Network Relay operates as a stateless DHCPv6 Relay Agent.

Further, in 3GPP Release 13, extensions of ProSe have been discussed (see, for example, Non-patent Literatures 2 to 8). This discussion includes a discussion about relay selection criteria for selecting a ProSe UE-to-Network Relay and a ProSe UE-to-UE Relay and a discussion about a relay selection procedure including arrangement of a relay selection. Note that the ProSe UE-to-UE Relay is a UE that relays traffic between two remote UEs.

Regarding the arrangement of the relay selection for the UE-to-Network Relay, a distributed relay selection architecture in which a remote UE selects a relay (see, for example, Non-patent Literatures 3-5, 7 and 8) and a centralized relay selection architecture in which an element in a network such as a base station (i.e., eNodeB (eNB)) selects a relay (see, for example, Non-patent Literatures 6 and 7) have been proposed. Regarding the criteria for the relay selection for the UE-to-Network Relay, it has been proposed to consider D2D link quality between a remote UE and a relay UE, consider backhaul link quality between a relay UE and an eNB, and consider both the D2D link quality and the backhaul link quality (see, for example, Non-patent Literatures 3 to 8).

For example, Non-patent Literature 3 to 5 discloses that both D2D link quality and backhaul link quality are considered in the distributed relay selection. In an example, a remote UE considers both the D2D link quality and the backhaul link quality by using an evaluation formula, i.e., w*D2D link quality+(1−w)*backhaul link quality, where w is a predefined constant (see Non-Patent Literature 3). In some implementations, a relay UE transmits a discovery message indicating radio quality of a backhaul link (i.e., between the relay UE and an eNB) to assist relay selection performed by a remote UE (see Non-Patent Literature 4). Alternatively, a relay UE may implicitly indicate radio quality of a backhaul link to a remote UE to assist relay selection performed by the remote UE. For example, priority information in a discovery signal is used to implicitly indicate the radio quality of the backhaul link (see Non-Patent Literature 5).

For example, Non-patent Literature 6 states that both D2D link quality and backhaul link quality are considered in the centralized relay selection. In an example, a remote UE reports D2D link quality to an eNB and the eNB selects a relay for the remote UE while considering the reported D2D link quality and (reported) backhaul link quality. The backhaul link quality may be acquired by a measurement performed by the eNB or by measurement reporting by the relay UE in an existing cellular network.

For example, in Non-Patent Literature 7 and 8, an eNB selects one or more relay candidate UEs while taking into account backhaul link quality. Only these relay candidate UEs can be found by the remote UE in the relay discovery procedure. The remote UE selects a relay from among the one or more relay candidates based on the D2D link quality. Since the backhaul link quality is considered in the selection of the relay candidates performed by the eNB, it is also indirectly considered in the relay selection performed by the remote UE.

In the specification, a radio terminal having the D2D communication capability and the relay capability, such as the ProSe UE-to-Network Relay and the ProSe UE-to-UE Relay, is referred to as a “relay radio terminal” or a “relay UE”. Further, a radio terminal that receives a relay service provided by a relay UE is referred to as a “remote radio terminal” or a “remote UE”.

### CITATION LIST

### Non Patent Literature

Non-patent Literature 1: 3GPP TS 23.303 V12.4.0 (2015 March), “3rd Generation Partnership Project; Technical Specification Group Services and System Aspects; Proximity-based services (ProSe); Stage 2 (Release 12)”, March 2015
Non-patent Literature 2: 3GPP TR 23.713 V1.4.0 (2015 June), “3rd Generation Partnership Project; Technical Specification Group Services and System Aspects; Study on extended architecture support for proximity-based services (Release 13)”, June 2015
Non-patent Literature 3: 3GPP R1-152778, “Support of UE-Network relays”, Qualcomm Incorporated, May 2015
Non-patent Literature 4: 3GPP S2-150925, “UE-to-Network Relay conclusions”, Qualcomm Incorporated, April 2015
Non-patent Literature 5: 3GPP R1-153087, “Discussion on UE-to-Network Relay measurement”, Sony, May 2015
Non-patent Literature 6: 3GPP R2-152560, “Role of eNB when remote UE is in coverage”, Qualcomm Incorporated, May 2015
Non-patent Literature 7: 3GPP R1-151965, “Views on UE-to-Network Relay Discovery”, NTT DOCOMO, April 2015
Non-patent Literature 8: 3GPP R1-153188, “Discussion on Relay Selection”, NTT DOCOMO, May 2015

### SUMMARY OF INVENTION

### Technical Problem

As described above, it has been proposed that the relay selection considers either or both of the D2D link quality and the backhaul link quality. However, in some cases, it may be inappropriate to perform the relay selection based solely on the levels (or magnitudes) of the D2D link quality and the backhaul link quality. For example, if a relay UE having good D2D link quality is selected based on an instantaneous (i.e., snapshot) magnitude of the D2D link quality, a relay UE that briefly passes the remote UE or a relay UE that tends to move away from the remote UE may be selected. These radio terminals may not be able to provide stable relay quality to the remote UE.

Accordingly, one of the objects to be attained by embodiments disclosed herein is to provide an apparatus, a method, and a program that contribute to improving a relay selection so as to provide stable relay quality.

### Solution to Problem

In a first aspect, a relay selecting apparatus includes a memory and at least one processor coupled to the memory. The at least one processor is configured to select at least one specific relay terminal suitable for a remote terminal from among one or more relay terminals based on a selection criterion that considers a time variation of a device-to-device (D2D) link quality between the remote terminal and each of the one or more relay terminals.

In a second aspect, a relay selecting method includes selecting at least one specific relay terminal suitable for a remote terminal from among one or more relay terminals based on a selection criterion that considers a time variation of a device-to-device (D2D) link quality between the remote terminal and each of the one or more relay terminals.

In a third aspect, a program includes a set of instructions (software codes) that, when loaded into a computer, causes the computer to perform a method according to the above-described second aspect.

### Advantageous Effects of Invention

According to the above-described aspects, it is possible to provide an apparatus, a method, and a program that contribute to improving a relay selection so as to provide stable relay quality.

### BRIEF DESCRIPTION OF DRAWINGS

FIG. 1 shows a configuration example of a radio communication network according to some embodiments;

FIG. 2 shows a configuration example of a radio communication network according to some embodiments;

FIG. 3 is a sequence diagram showing an example of a procedure for starting a relay according to some embodiments;

FIG. 4 is a sequence diagram showing an example of a procedure for starting a relay according to some embodiments;

FIG. 5 is a flowchart showing an example of a relay selection procedure according to a first embodiment;

FIG. 6 is a flowchart showing an example of a relay selection procedure according to a second embodiment;

FIG. 7 is a flowchart showing an example of a relay selection procedure according to a third embodiment;

FIG. 8 is a graph showing an example of a relation between D2D link quality and backhaul link quality for explaining the relay selection procedure according to the third embodiment;

FIG. 9 is a flowchart showing an example of a relay selection procedure according to a fourth embodiment;

FIG. 10 is a flowchart showing an example of an operation performed by a remote UE according to a fifth embodiment;

FIG. 11 is a block diagram showing a configuration example of a radio terminal according to some embodiments;

FIG. 12 is a block diagram showing a configuration example of a base station according to some embodiments; and

FIG. 13 is a block diagram showing a configuration example of a D2D controller according to some embodiments.

### DESCRIPTION OF EMBODIMENTS

Specific embodiments are described hereinafter in detail with reference to the drawings. The same or corresponding elements are denoted by the same symbols throughout the drawings, and duplicated explanations are omitted as necessary for the sake of clarity.

### First Embodiment

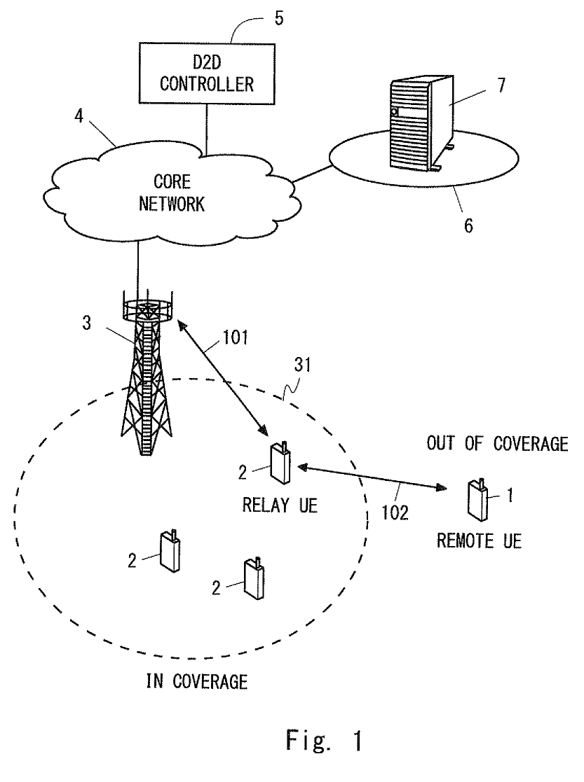

FIG. 1 shows a configuration example of a radio communication network according to some embodiments including this embodiment. Specifically, FIG. 1 shows an example related to a UE-to-Network Relay. That is, a remote UE 1 includes at least one radio transceiver and is configured to perform D2D communication (e.g., ProSe direct discovery and ProSe direct communication) with one or more relay UEs 2 on a D2D link 102 (e.g., PC5 interface or sidelink). Further, though not shown in FIG. 1, the remote UE 1 is configured to perform cellular communication in a cellular coverage 31 provided by one or more base stations 3.

Each relay UE 2 includes at least one radio transceiver and is configured to perform cellular communication with the base station 3 on a cellular link 101 in the cellular coverage 31 and perform D2D communication (e.g., ProSe direct discovery and ProSe direct communication) with the remote UE 1 on the D2D link 102.

The base station 3 is an entity disposed in a radio access network (i.e., E-UTRAN), provides the cellular coverage 31 including one or more cells, and is able to communicate with each relay UE 2 on the cellular link 101 by using a cellular communication technology (e.g., E-UTRA technology). Further, the base station 3 is configured to perform cellular communication with the remote UE 1 when the remote UE 1 is in the cellular coverage 31.

A core network (i.e., Evolved Packet Core (EPC)) 4 includes a plurality of user-plane entities (e.g., Serving Gateway (S-GW) and Packet Data Network Gateway (P-GW)) and a plurality of control-plane entities (e.g., Mobility Management Entity (MME) and Home Subscriber Server (HSS)). The user-plane entities relay user data of the remote UE 1 and user data of the relay UE 2 between an external network and a radio access network including the base station 3. The control-plane entities perform various types of control for the remote UE 1 and the relay UE 2 including mobility management, session management (bearer management), subscriber information management, and billing management.

In some implementations, the remote UE 1 and the relay UE 2 are configured to communicate with a D2D controller 5 through the base station 3 and the core network 4 to use a proximity-based service (e.g., 3GPP ProSe). For example, in the case of 3GPP ProSe, the D2D controller 5 corresponds to a ProSe function entity. The remote UE 1 and the relay UE 2 may use, for example, a network-level discovery (e.g., EPC-level ProSe Discovery) provided by the D2D controller 5, receive from the D2D controller 5 a message indicating a permission for the remote UE 1 and the relay UE 2 to start (or activate) D2D communication (e.g., ProSe direct discovery and ProSe direct communication), or receive from the D2D controller 5 configuration information regarding D2D communication in the cellular coverage 31.

In the example shown in FIG. 1, the relay UE 2 operates as a UE-to-Network Relay and provides the remote UE 1 with a relay operation between the remote UE 1 and the cellular network (i.e., the base station 3 and the core network 4). In other words, the relay UE 2 relays a data flow (traffic) related to the remote UE 1 between the remote UE 1 and the cellular network (i.e., the base station 3 and the core network 4). In this way, the remote UE 1 can communicate with a node 7 located in an external network 6 through the relay UE 2 and the cellular network (i.e., the base station 3 and the core network 4).

In the example shown in FIG. 1, the remote UE 1 is located outside the cellular coverage 31 (i.e., out of coverage). However, the remote UE 1 may be located inside the cellular coverage 31 but be unable to connect to the cellular network (i.e., the base station 3 and the core network 4) because of any conditions (e.g., because of user's choice). When the remote UE 1 is in the condition that it is unable to connect to the cellular network (e.g., out of coverage), the remote UE 1 performs D2D communication (e.g., direct communication) with the relay UE 2.

The condition that the remote UE 1 is unable to connect to the cellular network may be determined based on the fact that reception quality (e.g., Reference Signal Received Power (RSRP) or Reference Signal Received Quality (RSRQ)) of a radio signal transmitted from one or more base stations 3 located in the cellular network is equal to or lower than a predetermined threshold. In other words, the remote UE 1 may determine that it is unable to connect to the cellular network in response to detecting that it has not successfully received a radio signal from the cellular network. Alternatively, the remote UE 1 may determine that it is unable to connect to the cellular network in response to detecting that a connection (or attach) to the cellular network has been rejected although it can receive a radio signal from any base station 3. Alternatively, the remote UE 1 may determine that it is unable to connect to the cellular network in response to detecting that it has forcibly disconnected or deactivated its connection to the cellular network in accordance with an instruction from the user or from a control node (e.g., the base station 3, the D2D controller 5, or an Operation Administration and Maintenance (OAM) server)) located in the cellular network.

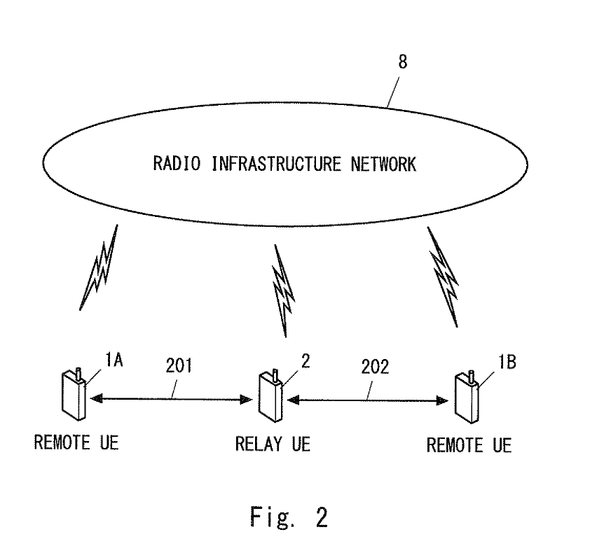

FIG. 2 shows another example of a configuration of a radio communication network according to some embodiments including this embodiment. Specifically, FIG. 2 shows an example related to a UE-to-UE Relay. In the example shown in FIG. 2, the relay UE 2 operates as a UE-to-UE Relay and relays traffic between a remote UE 1A and a remote UE 1B. In other words, the relay UE 2 performs D2D communication (e.g., ProSe direct discovery and ProSe direct communication) with the remote UE 1A on a one-to-one D2D link 201 and also performs D2D communication with the remote UE 1B on a one-to-one D2D link 202.

Each of the remote UEs 1A and 1B and the relay UE 2 may be configured to communicate with a radio infrastructure network 8. The radio infrastructure network 8 provides communication that is more continuous than D2D communication between radio terminals. The radio infrastructure network 8 may include a cellular network including the base station 3 and the core network 4 shown in FIG. 1. The cellular network may be, for example, a Universal Mobile Telecommunications System (UMTS), a Long Term Evolution (LTE), a CDMA2000 (1×RTT, High Rate Packet Data (HRPD)) system, a Global System for Mobile communications (GSM (Registered Trademark))/General packet radio service (GPRS) system, a WiMAX (IEEE 802.16-2004), or a mobile WiMAX (IEEE 802.16e-2005). Additionally or alternatively, the radio infrastructure network 8 may include an infrastructure-mode Wireless Local Area Network (WLAN) (IEEE 802.11) such as a public WLAN.

Note that from the viewpoint of the remote UE 1A in FIG. 2 regarding the UE-to-UE Relay, the D2D link 202 between the relay UE 2 and the other remote UE 1B can be assumed as a backhaul link. That is, the backhaul link in this specification means a radio link between the relay UE 2 and a next hop node (e.g., the base station 3 or another remote UE 1) that the relay UE 2 uses in order to relay traffic of the remote UE 1 of interest. Accordingly, the backhaul link in this specification may be a cellular link (e.g., Wide Area Network (WAN) link) between relay UE 2 and the base station 3, or may be a D2D link between the relay UE 2 and another remote UE 1 other than the remote UE 1 of interest.

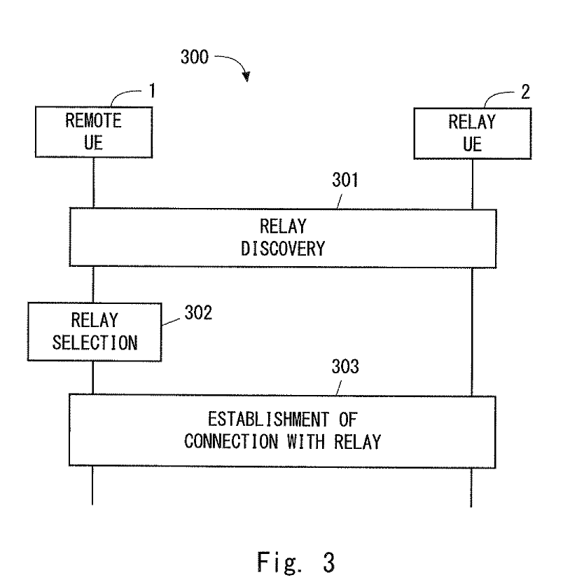

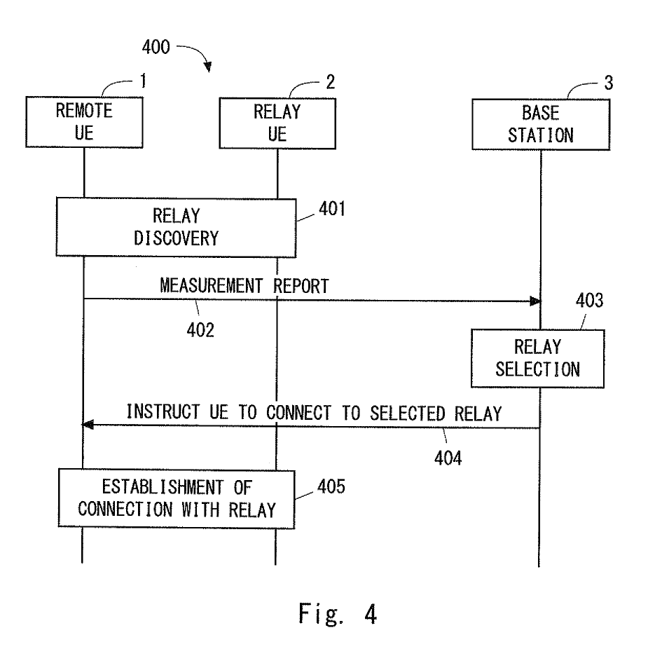

Next, a procedure for starting a relay according to some embodiments including this embodiment is described with reference to FIGS. 3 and 4. To start a relay, it is necessary to perform “relay discovery” to find one or more relay UEs 2 that the remote UE 1 can use and also perform a “relay selection” to select at least one specific relay UE suitable for the remote UE 1 from among the one or more found relay UEs 2. As already described, the relay selection is performed by the remote UE 1 in some implementations (i.e., the distributed relay selection), or it is performed by a network element such as the base station 3 in other implementations (i.e., the centralized relay selection).

FIG. 3 shows an example (a process 300) of a procedure according to the distributed relay selection. In block 301, the remote UE 1 and the relay UE 2 perform a relay discovery procedure so that the remote UE 1 finds the relay UE 2 which serves as a UE-to-Network Relay or a UE-to-UE Relay. For example, in accordance with the so-called announcement model (i.e., model A), the relay UE 2 may transmit a discovery signal and the remote UE 1 may find the relay UE 2 by detecting the discovery signal transmitted from the relay UE 2. Alternatively, in accordance with the so-called solicitation/response model (i.e., model B), the remote UE 1 may transmit a discovery signal indicating that it desires a relay and the relay UE 2 may transmit a response message to this discovery signal to the UE 1, and then the remote UE 1 may find the relay UE 2 by receiving the response message transmitted from the relay UE 2.

Each of the discovery signal (in model A) and the response message (in model B) transmitted from the relay UE 2 may include a relay UE ID and backhaul link quality. The backhaul link quality may include at least one of: reception quality (e.g., RSRP, RSRQ, or signal-to-interference plus noise ratio (SINR)) of a signal transmitted from a next hop node (e.g., the base station 3 or another remote UE 1) measured at each relay UE 2; a data rate or throughput between the next hop node and each relay UE 2; a delay time of communication between each relay UE 2 and the next hop node; and a modulation scheme and a coding rate (e.g., a Modulation and Coding Scheme (MCS) index) applied to communication between each relay UE 2 and the next hop node.

In block 302, the remote UE 1 selects at least one suitable specific relay UE 2 from among the one or more relay UEs 2 found in block 301. Details of a relay selection criterion according to this embodiment will be described later.

In block 303, the remote UE 1 establishes a connection for one-to-one D2D communication (i.e., direct communication) with any one of the at least one selected specific relay UE. For example, the remote UE 1 may transmit a direct communication request (or a relay request) to the relay UE 2. Upon receiving the direct communication request (or the relay request), the relay UE 2 may start a procedure for mutual authentication.

Meanwhile, FIG. 4 shows an example (a process 400) of a centralized relay selection. In block 401, similarly to block 301, the remote UE 1 and the relay UE 2 perform a relay discovery procedure so that the remote UE 1 finds the relay UE 2 which serves as a UE-to-Network Relay or a UE-to-UE Relay.

In block 402, the remote UE 1 transmits a measurement report to the base station 3. The measurement report is related to the one or more relay UEs 2 found in block 401 and includes, for example, D2D link quality (between the remote UE 1 and the relay UE 2). The D2D link quality may include, for example, at least one of received power, signal-to-interference plus noise ratio (SINR), and data rate (or throughput). Similarly to the existing measurement report, the measurement report may include cellular link quality between the remote UE 1 and the base station 3. Further, the measurement report may include backhaul link quality (between the base station 3 and the relay UE 2).

In block 402, the base station 3 selects at least one suitable specific relay UE 2 from among the one or more relay UEs 2 found by the remote UE 1 based on the reported D2D link quality between the remote UE 1 and each relay UE 2, the reported link quality between the remote UE 1 and the base station 3, and the backhaul link quality between the base station 3 and each relay UE 2. The backhaul link quality between the base station 3 and each relay UE 2 may be included in the measurement report transmitted from the remote UE 1. Alternatively, in particular in the case of the UE-to-Network Relay, the base station 3 may acquire the backhaul link quality by measuring an uplink signal from each relay UE 2. In other words, the backhaul link quality may be reception quality at the base station 3 of an uplink signal transmitted from each relay UE 2. Details of a relay selection criterion according to this embodiment will be described later.

In block 404, the base station 3 instructs the remote UE 1 to connect to the selected specific relay UE 2. In block 405, the remote UE 1 establishes a connection for one-to-one D2D communication (i.e., direct communication) with the specific relay UE according to the instruction from the base station 3.

Note that in the example shown in FIG. 4, the relay selection (block 403) may be performed by a network element other than the base station 3, e.g., by the D2D controller 5.

Next, a specific example of a relay selection criterion according to this embodiment is described. In the relay selection criterion according to this embodiment, a time variation of D2D link quality is considered. That is, a relay selecting entity is configured to select at least one specific relay UE suitable for a remote UE 1 from among one or more relay UEs 2 based on a selection criterion that considers a parameter representing a time variation of D2D link quality between the remote UE 1 and each of the one or more relay UEs 2. Note that as understood from the above explanation, the relay selecting entity according to this embodiment may be the remote UE 1 in the case of the distributed relay selection architecture or may be a network element (e.g., the base station 3 or the D2D controller 5) in the case of the centralized relay selection architecture.

The D2D link quality may include, for example, at least one of received power (e.g., RSRP or RSRQ), a signal-to-interference plus noise ratio (SINR)) and a data rate.

The parameter representing the time variation of D2D link quality may indicate, for example, at least one of a magnitude of the time variation of D2D link quality, a speed of the time variation of D2D link quality, and a tendency of the time variation of D2D link quality. In some implementations, the parameter may be derived from a difference (e.g., a time derivative) between measurement values of the D2D link quality to indicate the magnitude, speed, or tendency of the time variation of the D2D link quality. Additionally or alternatively, the parameter may represent statistical variability or statistical dispersion of the D2D link quality to indicate the magnitude or tendency of the time variation of the D2D link quality. To indicate the statistical variability or the statistical dispersion, the parameter may include a variance, standard deviation, or interquartile range (IQR) of the D2D link quality.

In some implementations, the relay selection criterion may be defined in such a manner that a relay UE 2 of which the magnitude of the time variation of the D2D link quality (between the remote UE 1 and that relay UE 2) is smaller is more likely to be selected as the specific relay UE for the remote UE 1. It can be expected that a relay UE 2 of which the time vitiation of the D2D link quality (between the remote UE 1 and that relay UE 2) is small is able to provide stable D2D link quality for the remote UE 1 and, hence, is able to provide stable overall relay quality.

As an example, the relay selection criterion may be defined by, for example, the following expression (1):

$${argmin}_{i} {f}_{ij} subjected to \text{:} {f}_{ij} = \vert \frac{{DQ}_{ij} ( {t}_{2} ) - {DQ}_{ij} ( {t}_{1} )}{{t}_{2} - {t}_{1}} \vert \qquad ( 1 )$$

where DQᵢⱼ(t) is the D2D link quality between the relay UE 2 (UE i) and the remote UE 1 (UE j) at a time t, and fᵢⱼ is a parameter representing the magnitude (i.e., absolute value) of the time variation of the D2D link quality. Note that the operator “arg min” in Expression (1) refers to a set of UEs i for which fᵢⱼ attains the minimum value. In other words, Expression (1) indicates that at least one relay UE 2 (UE i) for which the parameter fᵢⱼ representing the magnitude of the change in the D2D link quality attains the minimum value is selected for the remote UE 1 (UE j).

Alternatively, in some implementations, the relay selection criterion may be defined in such a manner that a relay UE 2 of which the speed of the time variation of the D2D link quality (between the remote UE 1 and that relay UE 2) is smaller is more likely to be selected as the specific relay UE for the remote UE 1. It can be expected that a relay UE 2 of which the speed of the time variation of the D2D link quality (between the remote UE 1 and that relay UE 2) is small is able to provide stable D2D link quality for the remote UE 1 and, hence, is able to provide stable overall relay quality. In other words, by taking the speed of the time variation of the D2D link quality into account in the relay selection, the possibility that a relay UE 2 that briefly passes the remote UE 1 could be selected can be lowered.

As an example, a parameter representing the speed of the time variation of the D2D link quality may be the magnitude of a change in the D2D link quality per unit time or may be the absolute value of the time derivative of the D2D link quality.

Alternatively, in some implementations, the relay selection criterion may be defined in such a manner that a relay UE 2 having the tendency of the time variation of its D2D link quality (between the remote UE 1 and that relay UE 2) in which the D2D link quality gradually improves is more likely to be selected as the specific relay UE for the remote UE 1 than other relays UE 2 that do not have such a tendency. It can be assumed that the fact that the D2D link quality (between the remote UE 1 and the relay UE 2) gradually improves means that the relay UE 2 and the remote UE 1 tend to get closer to each other, and accordingly it can be expected that this relay UE 2 is able to provide stable overall relay quality. In other words, by taking the tendency of the time variation of the D2D link quality into account in the relay selection, the possibility that a relay UE 2 that tends to move away from the remote UE 1 could be selected can be lowered.

As an example, a parameter representing the tendency of the time variation of the D2D link quality may be a sum of time derivatives of the D2D link quality. The stronger the tendency that the D2D link quality gradually improves is, the larger positive value the sum of time derivatives of the D2D link quality has. Meanwhile, the stronger the tendency that the D2D link quality gradually deteriorates is, the larger negative value the sum of time derivatives of the D2D link quality has. When the D2D link quality does not change, the sum of time derivatives of the D2D link quality gets closer to zero. Further, when the D2D link quality frequently increases and decreases, the sum of time derivatives of the D2D link quality also gets closer to zero.

Some of the above-described examples of the relay selection criterion that considers the time variation of the D2D link quality may be used in any combination with one another.

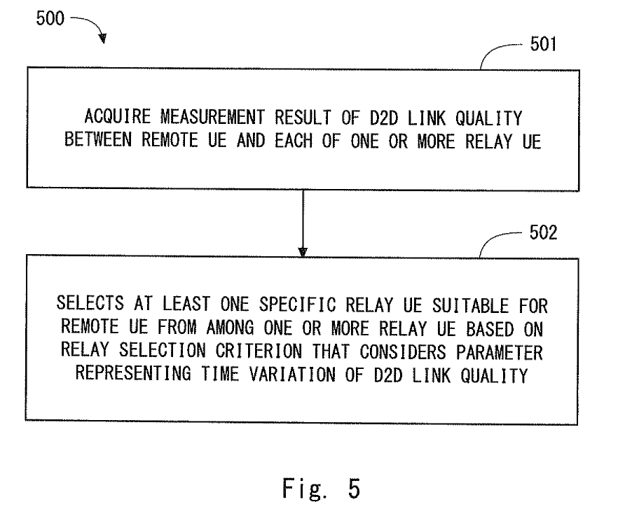

FIG. 5 is a flowchart showing an example (a process 500) of the relay selection procedure performed by the relay selecting entity (e.g., the remote UE 1, the base station 3, or the D2D controller 5) according to this embodiment. In block 501, the relay selecting entity acquires a result of measurement of the D2D link quality between the remote UE 1 and each of one or more relay UEs 2. As already described, this measurement result may be acquired by the remote UE 1 and used by the remote UE 1 that operates as the relay selecting entity. Alternatively, this measurement result may be acquired by the remote UE 1 or the relay UE 2 and reported from the remote UE 1 or the relay UE 2 to the base station 3 or the D2D controller 5 that operates as the relay selecting entity.

In block 502, the relay selecting entity selects at least one specific relay UE 2 suitable for the remote UE 1 from among the one or more relay UEs 2 based on the relay selection criterion that considers a parameter representing the time variation of the D2D link quality.

In the case in which a network node (e.g., the base station 3 or the D2D controller 5) selects a relay, the remote UE 1 may transmit a measurement report containing a parameter representing the time variation of the D2D link quality (e.g., a magnitude, speed, or tendency of the time variation) in block 501.

As understood from the above explanation, in this embodiment, the time variation of the D2D link quality (e.g., a magnitude, speed, or tendency of the time variation, or any combination thereof) is considered in the relay selection criterion. In this way, for example, the possibility that a relay UE 2 of which a change in D2D link quality is large could be selected can be lowered, or the possibility that a relay UE 2 that briefly passes the remote UE 1 could be selected can be lowered, or the possibility that a relay UE 2 that tends to move away from the remote UE 1 could be selected can be lowered. Therefore, the relay selection criterion and the relay selection procedure according to this embodiment can contribute to improving the relay selection so as to provide stable overall relay quality. Further, the relay selection criterion and the relay selection procedure according to this embodiment can prevent frequent occurrences of relay reselections.

### Second Embodiment

This embodiment provides modifications of the relay selection criterion and the relay selection procedure described in the first embodiment. A configuration example of a radio communication network and an example of a relay start procedure according to this embodiment are similar to those shown in FIGS. 1 to 4.

A relay selection criterion according to this embodiment considers a time variation of backhaul link quality (between a next hop node and a relay UE 2), as well as the time variation of the D2D link quality (between the remote UE 1 and each relay UE 2). As already described, in the case of the UE-to-Network Relay is the base station 3, and the next hop node in the case of the UE-to-UE Relay is another remote UE 1 other than the remote UE 1 of interest.

A relay selecting entity (e.g., the remote UE 1, the base station 3, or the D2D controller 5) according to this embodiment is configured to further consider, in the relay selection, a magnitude, speed, or tendency of the time variation of the backhaul link quality between each relay UE 2 and a next hop node. A parameter representing the time variation of the backhaul link quality may be defined in a manner similar to the parameter representing the time variation of D2D link quality described in the first embodiment. That is, the parameter representing the time variation of the backhaul link quality may be derived from a difference (e.g., a time derivative) between measurement values of the backhaul link quality. Additionally or alternatively, the parameter may represent statistical variability or statistical dispersion of the backhaul link quality to indicate the magnitude or tendency of the time variation of the backhaul link quality. To indicate the statistical variability or the statistical dispersion, the parameter may include a variance, standard deviation, or interquartile range (IQR) of the backhaul link quality.

For example, the time variation of the backhaul link quality may be considered in the relay selection in a manner similar to the time variation of the D2D link quality described in the first embodiment. Specifically, in some implementations, the relay selection criterion may be defined in such a manner that a relay UE 2 of which the magnitude of the time variation of the backhaul link quality (between the next hop node and that relay UE 2) is smaller is more likely to be selected as the specific relay UE for the remote UE 1. It can be expected that a relay UE 2 of which the magnitude of the time variation of the backhaul link quality (between the next hop node and that relay UE 2) is small is able to provide stable backhaul relay quality for the remote UE 1 and, hence, is able to provide stable overall relay quality.

As an example, the relay selection criterion may be defined by, for example, the following expressions (2) to (4):

$$\begin{matrix}{argmin}_{i} {f}_{ij} subjected to \text{:} {f}_{ij} = {w}_{1} \cdot {Δ}_{DQ} + ( 1 - {w}_{1} ) {Δ}_{RQB} & ( 2 ) \\ {Δ}_{DQ} = \vert \frac{{DQ}_{ij} ( {t}_{2} ) - {DQ}_{ij} ( {t}_{1} )}{{t}_{2} - {t}_{1}} \vert & ( 3 ) \\ {Δ}_{RBQ} = \vert \frac{{RBQ}_{i} ( {t}_{2} ) - {RBQ}_{i} ( {t}_{1} )}{{t}_{2} - {t}_{1}} \vert & ( 4 )\end{matrix}$$

where DQᵢⱼ(t) is the D2D link quality between the relay UE 2 (UE i) and the remote UE 1 (UE j) at a time t; RBQᵢ(t) is the backhaul link quality between the relay UE 2 (UE i) and the next hop node at the time t; a weight w₁ is a predefined constant between 0 and 1; and fᵢⱼ is a parameter that considers both the magnitude (i.e., absolute value) of the time variation of the D2D link quality and the magnitude (i.e., absolute value) of the time variation of the backhaul link quality.

Alternatively, in some implementations, the relay selection criterion may be defined in such a manner that a relay UE 2 of which the speed of the time variation of the backhaul link quality (between the next hop node and that relay UE 2) is smaller is more likely to be selected as the specific relay UE for the remote UE 1. It can be expected that a relay UE 2 of which the speed of the time variation of the backhaul link quality (between the next hop node and that relay UE 2) is small is able to provide stable backhaul relay quality for the remote UE 1 and, hence, is able to provide stable overall relay quality. In other words, by taking the speed of the time variation of the backhaul link quality into account in the relay selection, the possibility that a relay UE 2 that passes through the cellular coverage 31 (in particular, an area in which variations in cellular power are large) at a high speed could be selected can be lowered.

As an example, a parameter representing the speed of the time variation of the backhaul link quality may be the magnitude of a change in the backhaul link quality per unit time or may be the absolute value of the time derivative of the backhaul link quality.

Alternatively, in some implementations, the relay selection criterion may be defined in such a manner that a relay UE 2 having the tendency of the time variation of its backhaul link quality (between the next hop node and the relay UE 2) in which the backhaul link quality gradually improves is more likely to be selected as the specific relay UE for the remote UE 1 than other relays UE 2 that do not have such a tendency. It can be assumed that the fact that the backhaul link quality (between the next hop node and that relay UE 2) gradually improves means that the relay UE 2 is moving away from a coverage hole or an area outside the coverage, and accordingly it can be expected that this relay UE 2 continuously remains in good cellular communication environment. In other words, by taking the tendency of the time variation of the backhaul link quality into account in the relay selection, the possibility that a relay UE 2 that tends to move away from the center of the cell or get closer to an edge of the cell could be selected can be lowered.

As an example, a parameter representing the tendency of the time variation of the backhaul link quality may be a sum of time derivatives of the backhaul link quality.

Some of the above-described examples of the relay selection criterion that considers the time variation of backhaul link quality may be used in any combination with one another.

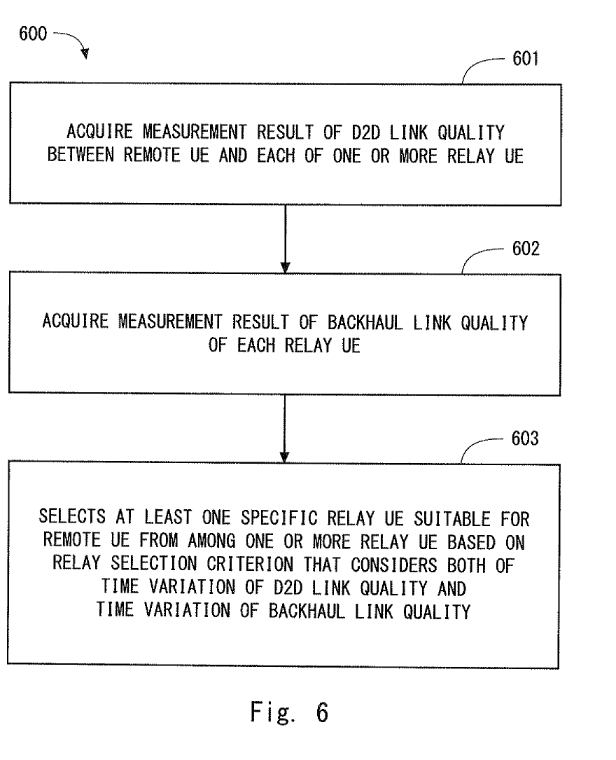

FIG. 6 is a flowchart showing an example (a process 600) of the relay selection procedure performed by the relay selecting entity (e.g., the remote UE 1, the base station 3, or the D2D controller 5) according to this embodiment. In block 601, the relay selecting entity acquires a result of measurement of the D2D link quality between the remote UE 1 and each of one or more relay UEs 2. As already described, this measurement result may be acquired by the remote UE 1 and used by the remote UE 1 that operates as the relay selecting entity. Alternatively, this measurement result may be acquired by the remote UE 1 or the relay UE 2 and reported from the remote UE 1 or the relay UE 2 to the base station 3 or the D2D controller 5 that operates as the relay selecting entity.

In block 602, the relay selecting entity acquires a result of measurement of the backhaul link quality of each relay UE 2. As already described, each relay UE 2 may measure backhaul link quality and inform the remote UE 1 of the measurement result of the backhaul link quality by using a discovery signal or a response message at the time of the relay discovery. The remote UE 1 that operates as the relay selecting entity may use the backhaul link quality received from each relay UE 2 for the relay selection. Alternatively, the remote UE 1 may report the backhaul link quality received from each relay UE 2 to a network entity (e.g., the base station 3 or the D2D controller 5) that operates as the relay selecting entity. Alternatively, a network entity (e.g., the base station 3 or the D2D controller 5) that operates as the relay selecting entity may use reception quality of an uplink signal received from each relay UE 2 measured by the base station 3 as the backhaul link quality.

In block 603, the relay selecting entity selects at least one specific relay UE 2 suitable for the remote UE 1 from among one or more relay UEs 2 based on the relay selection criterion that considers both the time variation of the D2D link quality and the time variation of the backhaul link quality.

In the case in which a network node (e.g., the base station 3 or the D2D controller 5) selects a relay, the remote UE 1 may transmit a measurement report containing a parameter representing the time variation of the D2D link quality (e.g., a magnitude, speed, or tendency of the time variation) in block 601. Further, the remote UE 1 may transmit a measurement report containing a parameter representing the time variation of the backhaul link quality (e.g., a magnitude, speed, or tendency of the time variation) in block 602.

As understood from the above explanation, in this embodiment, the time variation of the backhaul link quality (e.g., a magnitude, speed, or tendency of the time variation, or any combination thereof) is considered in the relay selection criterion. In this way, for example, the possibility that a relay UE 2 of which a change in backhaul link quality is large could be selected can be lowered, or the possibility that a relay UE 2 that passes through the cellular coverage 31 (in particular, an area in which variations in cellular power are large) at a high speed could be selected can be lowered, or the possibility that a relay UE 2 that tends to move away from the center of the cell (or get closer to a edge of the cell) could be selected is lowered. Therefore, the relay selection criterion and the relay selection procedure according to this embodiment can contribute to improving the relay selection so as to provide stable overall relay quality. Further, the relay selection criterion and the relay selection procedure according to this embodiment can prevent frequent occurrences of relay reselections.

### Third Embodiment

This embodiment provides modifications of the relay selection criteria and the relay selection procedures described in the first and second embodiments. A configuration example of a radio communication network and an example of a relay start procedure according to this embodiment are similar to those shown in FIGS. 1 to 4.

A relay selection criterion according to this embodiment considers D2D link quality itself (i.e., its quality level) and backhaul link quality itself (i.e., its quality level), as well as the time variation of the D2D link quality (between the remote UE 1 and each relay UE 2). Further, as described in the second embodiment, the relay selection criterion according to this embodiment may also consider the time variation of the backhaul link quality.

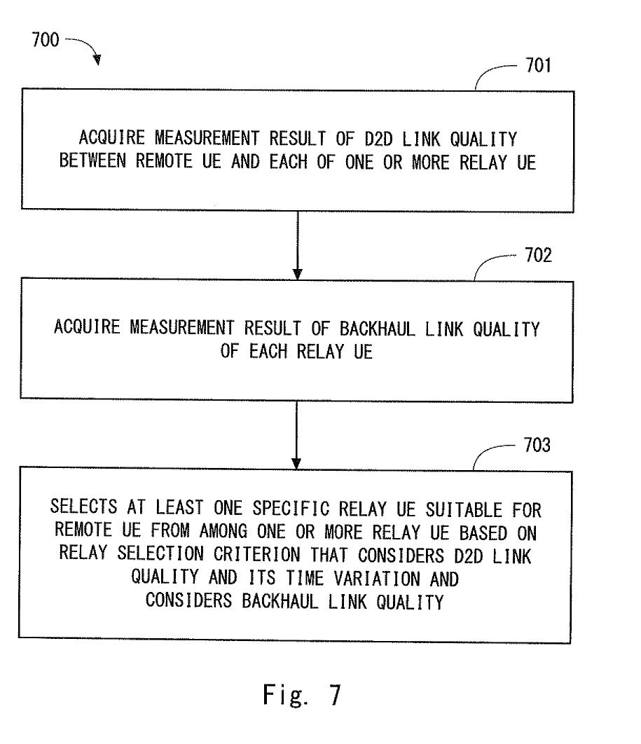

FIG. 7 is a flowchart showing an example (a process 700) of the relay selection procedure performed by the relay selecting entity (e.g., the remote UE 1, the base station 3, or the D2D controller 5) according to this embodiment. Processes in blocks 701 and 702 are similar to those in blocks 601 and 602 shown in FIG. 6. In block 703, the relay selecting entity selects at least one specific relay UE 2 suitable for the remote UE 1 from among one or more relay UEs 2 based on a relay selection criterion that considers the D2D link quality and its time variation and also considers the backhaul link quality.

The D2D link quality and the backhaul link quality may be considered for the relay selection as described below. As an example, when the D2D link quality itself (i.e., quality level) is sufficiently high, the relay UE 2 is probably able to provide stable relay quality even if the time variation of the D2D link quality is large or even if there is a tendency of the time variation of the D2D link quality in which it gradually deteriorates. Accordingly, when a relay UE 2 of which the D2D link quality (between the remote UE 1 and that relay UE 2) is equal to or higher than a first predetermined value exists, the relay selecting entity may select that relay UE 2 for the remote UE 1 irrespective of the time variation of the D2D link quality. On the other hand, when the D2D link quality of all the relay UEs 2 found by the remote UE 1 is lower than the first predetermined value, the relay selecting entity may select a specific relay UE(s) 2 for the remote UE 1 from among one or more relay UEs 2 each of which the D2D link quality higher than a second predetermined value (note that the second predetermined value is lower than the first predetermined value), according to the selection criterion that considers the time variation of the D2D link quality.

Similarly, when the backhaul link quality itself (i.e., its quality level) is sufficiently high, the relay UE 2 is probably able to provide stable relay quality even if the time variation of the backhaul link quality is large or even if there is the tendency of the time variation of the backhaul link quality in which it gradually deteriorates. Accordingly, when a relay UE 2 of which backhaul link quality is equal to or higher than a first predetermined value exists, the relay selecting entity may select that relay UE 2 for the remote UE 1 irrespective of the time variation of the link quality (between the remote UE 1 and the relay UE 2). On the other hand, when the backhaul link quality of all the relay UEs 2 found by the remote UE 1 is lower than the first predetermined value, the relay selecting entity may select a specific relay UE(s) 2 for the remote UE 1, from among one or more relay UEs 2 each having the backhaul link quality higher than a second predetermined value (note that the second predetermined value is lower than the first predetermined value), according to the selection criterion that considers the time variation of backhaul link quality.

Alternatively, in some implementations, the relay selection criterion that considers the D2D link quality and its time variation may be defined by, for example, the following expressions (5) and (6):

$$\begin{matrix}{argmin}_{i} {f}_{ij} subjected to \text{:} {f}_{ij} = {DQ}_{ij} ( {t}_{2} ) - {w}_{2} \cdot {Δ}_{DQ} & ( 5 ) \\ {Δ}_{DQ} = \vert \frac{{DQ}_{ij} ( {t}_{2} ) - {DQ}_{ij} ( {t}_{1} )}{{t}_{2} - {t}_{1}} \vert & ( 6 )\end{matrix}$$

where DQᵢⱼ(t) is the D2D link quality between the relay UE 2 (UE i) and the remote UE 1 (UE j) at a time t; a weight w₂ is a predefined constant; and fᵢⱼ is a parameter for considering the D2D link quality and the magnitude (i.e., absolute value) of the time variation thereof. The operator “arg max” in Expression (5) refers to a set of UEs i for which fᵢⱼ attains the maximum value. In other words, Expression (5) indicates that at least one relay UE 2 (UE i) for which the parameter fᵢⱼ that considers the D2D link quality and the magnitude (i.e., absolute value) of the time variation thereof attains the maximum value is selected for the remote UE 1 (UE j).

Alternatively, in some implementations, the relay selection criterion that considers the D2D link quality and its time variation and also considers the backhaul link quality may be defined by, for example, the following expressions (7) and (8):

$$\begin{matrix}{argmin}_{i} {f}_{ij} subjected to \text{:} {f}_{ij} = {DQ}_{ij} ( {t}_{2} ) + {w}_{3} \cdot {RBQ}_{i} ( {t}_{2} ) - {w}_{2} \cdot {Δ}_{DQ} & ( 7 ) \\ {Δ}_{DQ} = \vert \frac{{DQ}_{ij} ( {t}_{2} ) - {DQ}_{ij} ( {t}_{1} )}{{t}_{2} - {t}_{1}} \vert & ( 8 )\end{matrix}$$

where DQᵢⱼ(t) is D2D link quality between the relay UE 2 (UE i) and the remote UE 1 (UE j) at a time t; RBQᵢ(t) is backhaul link quality between the relay UE 2 (UE i) and the next hop node at the time t; weights w₂ and w₃ are predefined constants; and fᵢⱼ is a parameter that considers the D2D link quality and the magnitude (i.e., absolute value) of the time variation thereof and also considers the backhaul link quality.

Alternatively, in some implementations, the relay selection criterion that considers the D2D link quality and its time variation and also considers the backhaul link quality and its time variation may be defined by, for example, the following expressions (9) to (11):

$$\begin{matrix}{argmin}_{i} {f}_{ij} subjected to \text{:} \\ {DQ}_{ij} ( {t}_{2} ) + {w}_{3} \cdot {RBQ}_{i} ( {t}_{2} ) - {w}_{2} \{ {w}_{1} \cdot {Δ}_{DQ} + ( 1 - {w}_{1} ) {Δ}_{RBQ} \} & ( 9 ) \\ {Δ}_{DQ} = \vert \frac{{DQ}_{ij} ( {t}_{2} ) - {DQ}_{ij} ( {t}_{1} )}{{t}_{2} - {t}_{1}} \vert & ( 10 ) \\ {Δ}_{RBQ} = \vert \frac{{RBQ}_{i} ( {t}_{2} ) - {RBQ}_{i} ( {t}_{1} )}{{t}_{2} - {t}_{1}} \vert & ( 11 )\end{matrix}$$

where DQᵢⱼ(t) is D2D link quality between the relay UE 2 (UE i) and the remote UE 1 (UE j) at a time t; RBQᵢ(t) is backhaul link quality between the relay UE 2 (UE i) and the next hop node at the time t; a weight w₁ is a predefined constant between 0 and 1; weights w₂ and w₃ are predefined constants; and fᵢⱼ is a parameter that considers the D2D link quality and the magnitude (i.e., absolute value) of the time variation thereof and also considers the backhaul link quality and the magnitude of the time variation thereof.

Alternatively, in some implementations, the relay selection criterion may be defined in such a manner that a relay UE 2 having better overall relay quality that is restricted by a smaller one of the D2D link quality (between the remote UE 1 and the relay UE 2) and the backhaul link quality (between the next hop node and the relay UE 2) is more likely to be selected as the specific relay terminal for the remote UE 1. This is because a poorer one of the D2D link quality and the backhaul link quality probably becomes a bottleneck that restricts the relay quality.

For example, the relay selection criterion may be defined by the following expression (12) or (13):

$$\begin{matrix}{argmin}_{i} {f}_{ij} subjected to \text{:} {f}_{ij} = {\sum }_{t = T 1}^{T 2} min ( {DQ}_{ij} ( t ) , {RBQ}_{i} ( t ) ) & ( 12 ) \\ {argmin}_{i} {f}_{ij} subjected to \text{:} {f}_{ij} = {\sum }_{T 1}^{T 2} min ( {DQ}_{ij} ( t ) , {RBQ}_{i} ( t ) ) dt & ( 13 )\end{matrix}$$

where DQᵢⱼ(t) is D2D link quality between the relay UE 2 (UE i) and the remote UE 1 (UE j) at a time t, and RBQᵢ(t) is the backhaul link quality between the relay UE 2 (UE i) and the next hop node at the time t. In Expressions (12) and (13), the parameter fᵢⱼ is restricted by a lower one of the D2D link quality and the backhaul link quality at each time and hence represents overall relay quality.

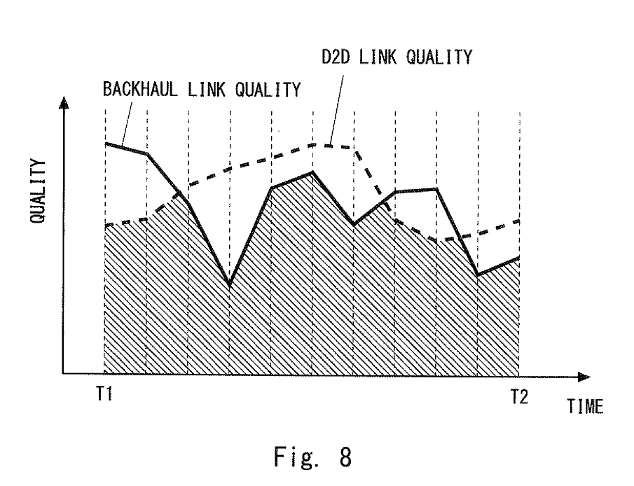

The meaning of the parameter fᵢⱼ expressed by Expressions (12) and (13) can be understood by a specific example shown in FIG. 8. FIG. 8 shows an example of a plurality of measurement values of the D2D link quality and a plurality of measurement values of the backhaul link quality in a certain time range T1 to T2. The parameter fᵢⱼ expressed by Expressions (12) and (13) uses a smaller one of the D2D link quality and the backhaul link quality and, accordingly, considers in the relay selection an area hatched by oblique lines in FIG. 8. Therefore, as understood from the specific example shown in FIG. 8, the parameter fᵢⱼ expressed by Expressions (12) and (13) makes it possible to effectively consider, in the relay selection, one of the D2D link quality and the backhaul link quality that becomes a bottleneck at each time.

### Fourth Embodiment

This embodiment provides modifications of the relay selection criteria and the relay selection procedures described in the first to third embodiments. A configuration example of a radio communication network and an example of a relay start procedure according to this embodiment are similar to those shown in FIGS. 1 to 4.

The relay selection criterion according to this embodiment considers other parameters regarding a load on the relay UE 2 as well as the time variation of the D2D link quality (between the remote UE 1 and the relay UE 2). As the parameter regarding the load on the relay UE 2, for example, the number of remote UEs 1 for which each relay UE 2 is already serving as a relay may be considered. Additionally or alternatively, as the parameter regarding the load on the relay UE 2, an amount of transmission data (e.g., amount of uplink transmission data or amount of buffered uplink data to be transmitted) of each relay UE 2 itself may be considered. In this way, by taking the load status (or a communication status) of each relay UE 2 into account in the relay selection, it is possible to mitigate the concentration of loads onto a specific relay UE 2 and share the loads among a plurality of relay UEs 2. Not that similarly to the second and third embodiments, the relay selection criterion according to this embodiment may also consider the time variation of the backhaul link quality, or consider the D2D link quality itself (i.e., its quality level) and the backhaul link quality itself (i.e., its quality level).

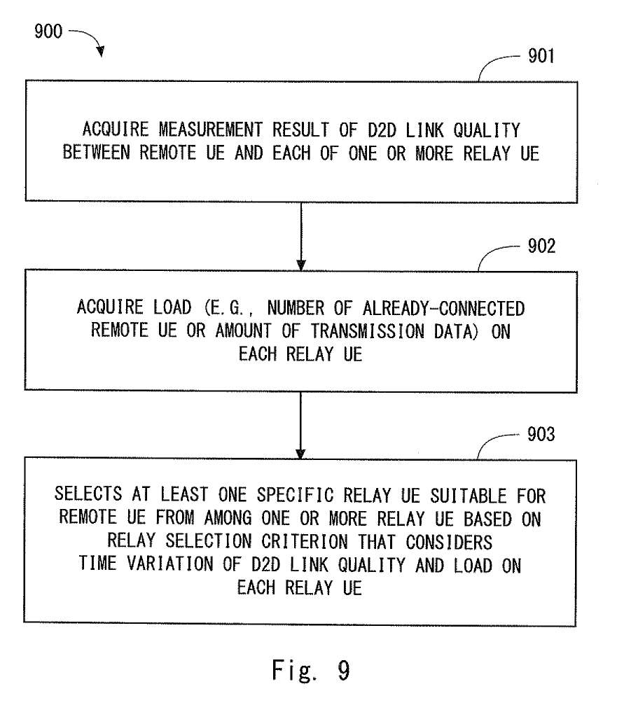

FIG. 9 is a flowchart showing an example (a process 900) of the relay selection procedure performed by the relay selecting entity (e.g., the remote UE 1, the base station 3, or the D2D controller 5) according to this embodiment. A process in block 901 is similar to the process in blocks 501 in FIG. 5, the process in blocks 601 in FIG. 6, or the process in blocks 701 in FIG. 7. In block 902, the relay selecting entity acquires a load on each relay UE 2 (e.g., the number of UEs already connected to the relay UE or an amount of transmission data). In block 903, the relay selecting entity selects at least one specific relay UE 2 suitable for the remote UE 1 from among one or more relay UEs 2 based on the relay selection criterion that considers the time variation of the D2D link quality and the load on each relay UE.

### Fifth Embodiment

This embodiment provides modifications of the relay selection criteria and the relay selection procedures described in the first to fourth embodiments. A configuration example of a radio communication network and an example of a relay start procedure according to this embodiment are similar to those shown in FIGS. 1 to 4.

In this embodiment, a relay selecting entity (e.g., the remote UE 1, the base station 3, or the D2D controller 5) selects two or more relay UEs 2 for one remote UE 1 based on a relay selection criterion. The relay selection criterion may be one of the relay selection criteria described in the first to fourth embodiments. In this way, the relay selecting entity can determine in advance a reserve relay UE(s) 2 for the remote UE 1. For example, the remote UE 1 may start communicating with the relay UE 2 having the highest priority among the two or more relay UEs 2, and when the relay quality of the relay UE 2 having the highest priority is deteriorated, the remote UE 1 may switch from the relay UE 2 having the highest priority to the relay UE 2 having the second-highest priority. In this way, it is possible to reduce the duration of disconnection caused by relay reselection.

In some implementations, the relay selecting entity may select two or more relay UEs 2 according to the same relay selection criterion. In this way, the relay selecting entity can easily determine the relay UE 2 having the highest priority, the relay UE 2 having the second-highest priority, and so on.

Alternatively, the relay selection entity may select two or more relay UEs 2 according to different relay selection criteria. In this way, the relay selecting entity can select a plurality of relay UEs 2 having different attributes. For example, the relay selecting entity may use a first relay selection criterion according to which a relay UE 2 having high D2D link quality and high backhaul link quality is preferentially selected and also use a second relay selection criterion according to which a relay UE 2 of which a time variation of D2D link quality and a time variation of backhaul link quality are small is preferentially selected. In this way, the relay selecting entity can select, for the remote UE 1, a first relay UE 2 expected to provide high relay quality (high throughput) though it may be provided only in a short period, and a second relay UE 2 expected to provide relay quality that is stable over a long period though the provided relay quality may not be very high.

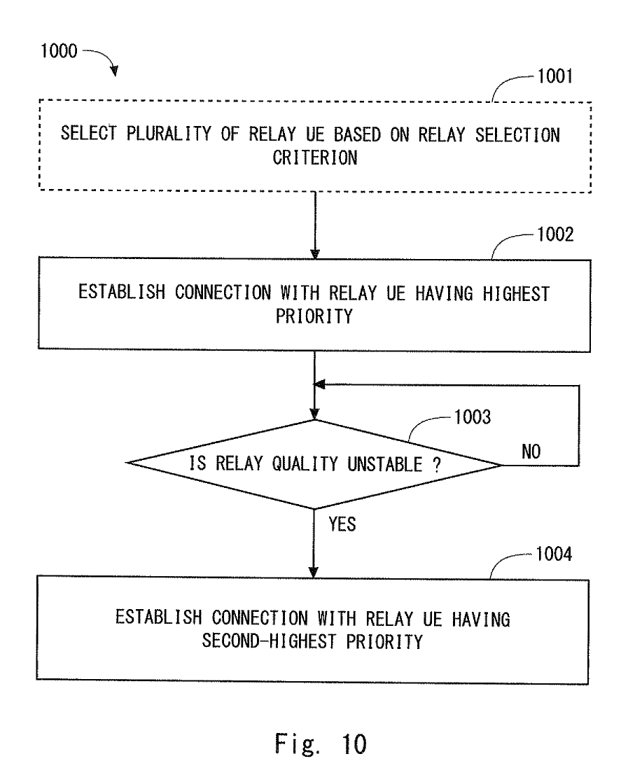

FIG. 10 is a flowchart showing an example (a process 1000) of an operation performed by the remote UE 1 according to this embodiment. In block 1001, the remote UE 1 selects a plurality of relay UEs 2 based on the relay selection criterion(s). As already described, the relay selection in blocks 1001 may be performed by a network node (e.g., the base station 3 or the D2D controller 5), instead of being performed by the remote UE 1.

In block 1002, the remote UE 1 establishes a connection with a relay UE 2 having the highest priority. In block 1003, the remote UE 1 determines whether the link quality provided by the relay UE 2 having the highest priority is unstable. When the link quality provided by the relay UE 2 having the highest priority is unstable (YES at block 1003), the remote UE 1 determines to switch from the relay UE 2 having the highest priority to a relay UE 2 having the second-highest priority. Then, in block 1001, the remote UE 1 establishes a connection with the relay UE 2 having the second-highest priority.

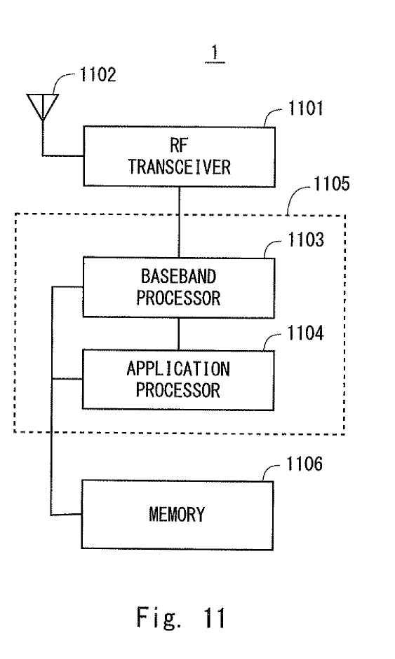

Lastly, configuration examples of the remote UE 1, the relay UE 2, the base station 3, and the D2D controller 5 according to the above-described plurality of embodiments will be described. FIG. 11 is a block diagram showing a configuration example of the remote UE 1. The relay UE 2 may have a configuration similar to that shown in FIG. 11. A Radio Frequency (RF) transceiver 1101 performs an analog RF signal processing to communicate with the base station 3. The analog RF signal processing performed by the RF transceiver 1101 includes a frequency up-conversion, a frequency down-conversion, and amplification. The RF transceiver 1101 is coupled to an antenna 1102 and a baseband processor 1103. That is, the RF transceiver 1101 receives modulated symbol data (or OFDM symbol data) from the baseband processor 1103, generates a transmission RF signal, and supplies the generated transmission RF signal to the antenna 1102. Further, the RF transceiver 1101 generates a baseband reception signal based on a reception RF signal received by the antenna 1102 and supplies the generated baseband reception signal to the baseband processor 1103.

The baseband processor 1103 performs digital baseband signal processing (i.e., data-plane processing) and control-plane processing for radio communication. The digital baseband signal processing includes (a) data compression/decompression, (b) data segmentation/concatenation, (c) composition/decomposition of a transmission format (i.e., transmission frame), (d) channel coding/decoding, (e) modulation (i.e., symbol mapping)/demodulation, and (f) generation of OFDM symbol data (i.e., baseband OFDM signal) by Inverse Fast Fourier Transform (IFFT). On the other hand, the control-plane processing includes communication management of layer 1 (e.g., transmission power control), layer 2 (e.g., radio resource management and hybrid automatic repeat request (HARQ) processing), and layer 3 (e.g., signaling regarding attach, mobility, and call management).

For example, in the case of LTE or LTE-Advanced, the digital baseband signal processing performed by the baseband processor 1103 may include signal processing of Packet Data Convergence Protocol (PDCP) layer, Radio Link Control (RLC) layer, MAC layer, and PHY layer. Further, the control-plane processing performed by the baseband processor 1103 may include processing of Non-Access Stratum (NAS) protocol, RRC protocol, and MAC CE.

The baseband processor 1103 may include a modem processor (e.g., Digital Signal Processor (DSP)) that performs the digital baseband signal processing and a protocol stack processor (e.g., Central Processing Unit (CPU) or a Micro Processing Unit (MPU)) that performs the control-plane processing. In this case, the protocol stack processor, which performs the control-plane processing, may be integrated with an application processor 1104 described in the following.

The application processor 1104 may also be referred to as a CPU, an MPU, a microprocessor, or a processor core. The application processor 1104 may include a plurality of processors (processor cores). The application processor 1104 loads a system software program (Operating System (OS)) and various application programs (e.g., voice call application, WEB browser, mailer, camera operation application, and music player application) from a memory 1106 or from another memory (not shown) and executes these programs, thereby providing various functions of the remote UE 1.

In some implementations, as represented by a dashed line (1105) in FIG. 11, the baseband processor 1103 and the application processor 1104 may be integrated on a single chip. In other words, the baseband processor 1103 and the application processor 1104 may be implemented in a single System on Chip (SoC) device 1105. A SoC device may be referred to as a system Large Scale Integration (LSI) or a chipset.

The memory 1106 is a volatile memory, a nonvolatile memory, or a combination thereof. The memory 1106 may include a plurality of memory devices that are physically independent from each other. The volatile memory is, for example, a Static Random Access Memory (SRAM), a Dynamic RAM (DRAM), or a combination thereof. The non-volatile memory is, for example, a mask Read Only Memory (MROM), an Electrically Erasable Programmable ROM (EEPROM), a flash memory, a hard disc drive, or any combination thereof. The memory 1106 may include, for example, an external memory device that can be accessed by the baseband processor 1103, the application processor 1104, and the SoC 1105. The memory 1106 may include an internal memory device that is integrated in the baseband processor 1103, the application processor 1104, or the SoC 1105. Further, the memory 1106 may include a memory in a Universal Integrated Circuit Card (UICC).

The memory 1106 may store software module (a computer program) including instructions and data to perform processing by the remote UE 1 described in the aforementioned plurality of embodiments. In some implementations, the baseband processor 1103 or the application processor 1104 may be configured to load the software module from the memory 1106 and execute the loaded software module, thereby performing the processing of the remote UE 1 described by using the sequence diagrams and the flowcharts in the aforementioned embodiments.

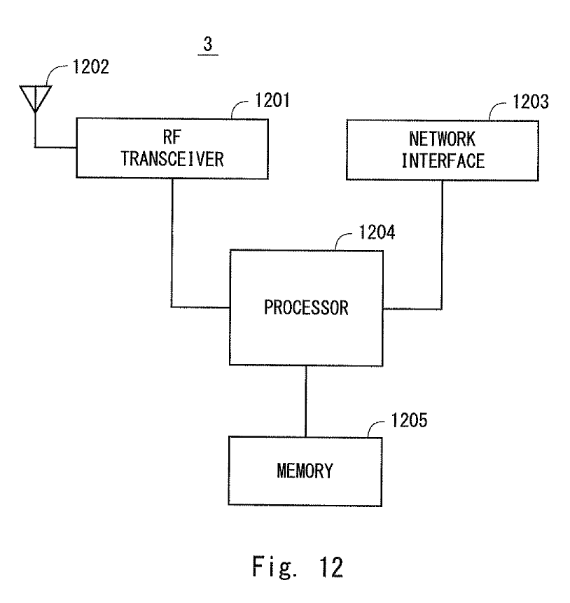

FIG. 12 is a block diagram showing a configuration example of the base station 3 according to the above-described embodiment. As shown in FIG. 12, the base station 3 includes an RF transceiver 1201, a network interface 1203, a processor 1204, and a memory 1205. The RF transceiver 1201 performs analog RF signal processing to communicate with the remote UE 1 and the relay UE 2. The RF transceiver 1201 may include a plurality of transceivers. The RF transceiver 1201 is connected to an antenna 1202 and the processor 1204. The RF transceiver 1201 receives modulated symbol data (or OFDM symbol data) from the processor 1204, generates a transmission RF signal, and supplies the generated transmission RF signal to the antenna 1202. Further, the RF transceiver 1201 generates a baseband reception signal based on a reception RF signal received by the antenna 1202 and supplies this signal to the processor 1204.

The network interface 1203 is used to communicate with a network node (e.g., Mobility Management Entity (MME) and Serving Gateway (S-GW)). The network interface 1203 may include, for example, a network interface card (NIC) conforming to the IEEE 802.3 series.

The processor 1204 performs digital baseband signal processing (data-plane processing) and control-plane processing for radio communication. For example, in the case of LTE or LTE-Advanced, the digital baseband signal processing performed by the processor 1204 may include signal processing of the PDCP layer, RLC layer, MAC layer, and PHY layer. Further, the control-plane processing performed by the processor 1204 may include processing of S1 protocol, RRC protocol, and MAC CE.

The processor 1204 may include a plurality of processors. For example, the processor 1204 may include a modem-processor (e.g., DSP) that performs the digital baseband signal processing, and a protocol-stack-processor (e.g., CPU or MPU) that performs the control-plane processing.

The memory 1205 is composed of a combination of a volatile memory and a nonvolatile memory. The volatile memory is, for example, an SRAM, a DRAM, or a combination thereof. The nonvolatile memory is, for example, an MROM, a PROM, a flash memory, a hard disk drive, or a combination thereof. The memory 1205 may include a storage located apart from the processor 1204. In this case, the processor 1204 may access the memory 1205 through the network interface 1203 or an I/O interface (not shown).

The memory 1205 may store software module (a computer program) including instructions and data to perform processing by the base station 3 described in the aforementioned plurality of embodiments. In some implementations, the processor 1204 may be configured to load the software module from the memory 1205 and execute the loaded software module, thereby performing the processing of the base station 3 described by using the sequence diagrams and the flowcharts in the aforementioned embodiments.

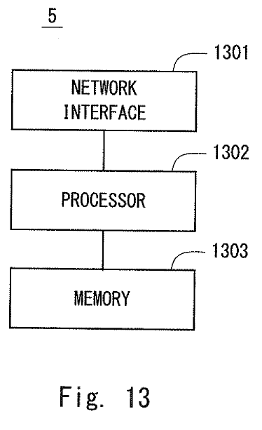

FIG. 13 is a block diagram showing a configuration example of the D2D controller 5 according to the above-described embodiment. As shown in FIG. 13, the D2D controller 5 includes a network interface 1301, a processor 1302, and a memory 1303. The network interface 1301 is used to communicate with the remote UE 1 and the relay UE 2. The network interface 1301 may include, for example, a network interface card (NIC) conforming to the IEEE 802.3 series.

The processor 1302 loads software (i.e., computer program(s)) from the memory 1303 and executes the loaded software, thereby performing processing of the D2D controller 5 described by using the sequence diagrams and the flowcharts in the above embodiments. The processor 1302 may be, for example, a microprocessor, an MPU, or a CPU. The processor 1302 may include a plurality of processors.

The memory 1303 is composed of a combination of a volatile memory and a nonvolatile memory. The memory 1303 may include a storage located apart from the processor 1302. In this case, the processor 1302 may access the memory 1303 through an I/O interface (not shown).

In the example shown in FIG. 13, the memory 1303 is used to store a group of software modules including a control module for D2D communication. The processor 1302 can perform the processing of the D2D controller 5 described by in the aforementioned embodiments by loading the group of software modules from the memory 1303 and executing the loaded software modules.

As described above with reference to FIGS. 11 to 13, each of the processors included in the remote UE 1, the relay UE 2, the base station 3, and the D2D controller 5 in the above embodiments executes one or more programs including a set of instructions to cause a computer to perform an algorithm described above with reference to the drawings. These programs may be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a Compact Disc Read Only Memory (CD-ROM), CD-R, CD-R/W, and a semiconductor memory (such as a mask ROM, a Programmable ROM (PROM), an Erasable PROM (EPROM), a flash ROM, and a Random Access Memory (RAM)). These programs may be supplied to computers by using various types of transitory computer readable media. Examples of the transitory computer readable media include an electrical signal, an optical signal, and an electromagnetic wave. The transitory computer readable media can be used to supply programs to a computer through a wired communication line (e.g., electric wires and optical fibers) or a wireless communication line.

### Other Embodiments

Each of the above embodiments may be used individually, or two or more of the embodiments may be appropriately combined with one another.

The relay selection criterion described in the second embodiment, which considers a time variation of backhaul link quality, may be used independently of the relay selection criterion that considers a time variation of D2D link quality. In other words, the relay selection criterion described in the second embodiment, which considers a time variation of backhaul link quality, can be used even in cases in which the time variation of D2D link quality is not considered. The relay selection criterion that considers a time variation of backhaul link quality can be expected to reduce, for example, the possibility that a relay UE 2 of which a change in backhaul link quality is large could be selected, the possibility that a relay UE 2 that passes through the cellular coverage 31 (in particular, an area in which variations in cellular power are large) at a high speed could be selected, or the possibility that a relay UE 2 that tends to move away from the center of the cell (or get closer to the edge of the cell) could be selected. Therefore, the relay selection criterion that considers the time variation of backhaul link quality can contribute to improving the relay selection so as to provide stable overall relay quality even in cases in which the time variation of the D2D link quality is not considered.

The relay selection criterion described in the fourth embodiment, which considers a load on a relay UE, may be used independently of the relay selection criterion that considers a time variation of D2D link quality. In other words, the relay selection criterion described in the fourth embodiment, which considers a load on a relay UE 2, can be used even in cases in which the time variation of D2D link quality is not considered. The relay selection criterion that considers a load on a relay UE 2 can prevent loads from being concentrated on a specific relay UE 2 and adjust the loads among a plurality of relay UEs 2 even in cases in which the time variation of the D2D link quality is not considered.

The process for selecting a plurality of relay UEs 2 for one remote UE 1 described in the fifth embodiment may be used independently of the relay selection criterion that considers a time variation of D2D link quality. In other words, the process for selecting a plurality of relay UEs 2 for one remote UE 1 described in the fifth embodiment can be used even in cases in which the time variation of D2D link quality is not considered. The process for selecting a plurality of relay UEs 2 for one remote UE 1 can contribute to reducing the duration of communication disconnection caused by relay reselection even in cases in which the time variation of the D2D link quality is not considered.

Further, the above-described embodiments are merely examples of applications of the technical ideas obtained by the inventor. Needless to say, these technical ideas are not limited to the above-described embodiments and various modifications can be made thereto.

This application is based upon and claims the benefit of priority from Japanese patent application No. 2015-126676, filed on Jun. 24, 2015, the disclosure of which is incorporated herein in its entirety by reference.

### REFERENCE SIGNS LIST

1 REMOTE UE
2 RELAY UE
3 BASE STATION
4 CORE NETWORK
5 DEVICE-TO-DEVICE (D2D) CONTROLLER
6 EXTERNAL NETWORK
7 NODE
1101 RADIO FREQUENCY (RF) TRANSCEIVER
1103 BASEBAND PROCESSOR
1104 APPLICATION PROCESSOR
1106 MEMORY
1204 PROCESSOR
1205 MEMORY
1302 PROCESSOR
1303 MEMORY

1. A relay selecting apparatus comprising:
a memory; and
at least one processor coupled to the memory, wherein
the at least one processor is configured to select at least one specific relay terminal suitable for a remote terminal from among one or more relay terminals based on a selection criterion that considers a time variation of a device-to-device (D2D) link quality between the remote terminal and each of the one or more relay terminals.

2. The relay selecting apparatus according to claim 1, wherein the selection criterion is adapted to use a parameter indicating at least one of a magnitude of the time variation of the D2D link quality, a speed of the time variation of the D2D link quality, and a tendency of the time variation of the D2D link quality.

3. The relay selecting apparatus according to claim 2, wherein the selection criterion is defined in such a manner that a relay terminal of which the magnitude of the time variation of the D2D link quality is smaller is more likely to be selected as the at least one specific relay terminal.

4. The relay selecting apparatus according to claim 2, wherein the selection criterion is defined in such a manner that a relay terminal of which the speed of the time variation of the D2D link quality is smaller is more likely to be selected as the at least one specific relay terminal.

5. The relay selecting apparatus according to claim 2, wherein the selection criterion is defined in such a manner that a relay terminal having the tendency of the time variation of the D2D link quality in which the D2D link quality gradually improves is more likely to be selected as the at least one specific relay terminal than a relay terminal that does not have such a tendency.

6. The relay selecting apparatus according to claim 1, wherein the selection criterion is adapted to use a parameter derived from a difference between measurement values of the D2D link quality.

7. The relay selecting apparatus according to claim 1, wherein the selection criterion is adapted to use a parameter representing statistical variability or statistical dispersion of the D2D link quality.

8. The relay selecting apparatus according to claim 7, wherein the parameter includes a variance, a standard deviation, or an interquartile range (IQR) of the D2D link quality.

9. The relay selecting apparatus according to claim 1, wherein the selection criterion is defined so as to further consider a magnitude of a time variation of a backhaul link quality between each of the one or more relay terminals and a next hop node, a speed of the time variation of the backhaul link quality, and a tendency of the time variation of the backhaul link quality.

10. The relay selecting apparatus according to claim 9, wherein the selection criterion is defined in such a manner that a relay terminal of which the magnitude of the time variation of the backhaul link quality is smaller is more likely to be selected as the at least one specific relay terminal.

11. The relay selecting apparatus according to claim 9, wherein the selection criterion is defined in such a manner that a relay terminal of which the speed of the time variation of the backhaul link quality is smaller is more likely to be selected as the at least one specific relay terminal.

12. The relay selecting apparatus according to claim 9, wherein the selection criterion is defined in such a manner that a relay terminal having the tendency of the time variation of the backhaul link quality in which the backhaul link quality gradually improves is more likely to be selected as the at least one specific relay terminal than a relay terminal that does not have such a tendency.

13. The relay selecting apparatus according to claim 1, wherein the selection criterion is defined so as to further consider the D2D link quality.

14. (canceled)

15. The relay selecting apparatus according to claim 13, wherein the selection criterion is defined so as to further consider a backhaul link quality between each of the one or more relay terminals and a next hop node.

16. The relay selecting apparatus according to claim 15, wherein the selection criterion is defined in such a manner that a relay terminal having a better overall relay quality is more likely to be selected as the at least one specific relay terminal, the overall relay quality being restricted by a smaller one of the D2D link quality and the backhaul link quality.

17. (canceled)

18. (canceled)

19. The relay selecting apparatus according to claim 1, wherein the selection criterion is defined so as to further consider the number of remote terminals for which each of the one or more relay terminals is already serving as a relay.

20. The relay selecting apparatus according to claim 1, wherein the selection criterion is defined so as to further consider an amount of transmission data of each of the one or more relay terminal itself.

21. The relay selecting apparatus according to claim 1, wherein the at least one processor is configured to select two or more relay terminals as the at least one specific relay terminal.

22. The relay selecting apparatus according to claim 21, wherein the at least one processor is configured to select the two or more relay terminals according to different selection criteria.

23. (canceled)

24. A relay selecting method comprising:
selecting at least one specific relay terminal suitable for a remote terminal from among one or more relay terminals based on a selection criterion that considers a time variation of a device-to-device (D2D) link quality between the remote terminal and each of the one or more relay terminals.

25-36. (canceled)
